(19) United States
(12) Patent Application Publication
(10) Pub. No.: US 2024/0111668 A1
(43) Pub. Date: Apr. 4, 2024

(54) ELASTIC COLUMN STORE WITH MINIMAL IMPACT ON WORKLOAD USING SMART EVICTION AND FAST REPOPULATION

(71) Applicant: Oracle International Corporation, Redwood Shores, CA (US)

(72) Inventors: Hariharan Lakshmanan, Brisbane, CA (US); Teck Hua Lee, Newark, CA (US); Vinita Subramanian, Campbell, CA (US); Gary Smith, Auburn, CA (US); Lijian Wan, Mountain View, CA (US); Shasank Kisan Chavan, Mountain View, CA (US); Venkat Raman Senapati, Sunnyvale, CA (US)

(21) Appl. No.: 18/374,944

(22) Filed: Sep. 29, 2023

Related U.S. Application Data
(60) Provisional application No. 63/411,795, filed on Sep. 30, 2022.

(51) Int. Cl. G06F 12/02

(52) U.S. Cl. CPC G06F 12/023

(57) ABSTRACT

Techniques are provided for implementing an in-memory columnar data store that is configured to either grow or shrink in response to performance prediction data generated from database workload information. A system maintains allocations of volatile memory from a given memory area for a plurality of memory-consuming components in a database system. The system receives for each memory-consuming component, performance prediction data that contains performance predictions for a plurality of memory allocation sizes for the memory-consuming components. The system determines a target memory allocation for an in-memory columnar data store based on the performance predictions. The system determines an incrementally adjusted amount of memory for the in-memory columnar data store and causes the incrementally adjusted amount to be allocated to the in-memory columnar data store.

### CROSS-REFERENCE TO RELATED APPLICATIONS; BENEFIT CLAIM

This application claims the benefit of Provisional Application 63/411,795, filed Sep. 30, 2022, the entire contents of which is hereby incorporated by reference as if fully set forth herein, under 35 U.S.C. § 119(e).

### FIELD OF THE INVENTION

The present invention relates to automatically resizing memory allocations within a shared memory area of a database server. Specifically, the present invention relates to modifying the allocation of in-memory areas based on a varying database workload.

### BACKGROUND

In-memory databases are purpose-built databases that rely primarily on memory for data storage. In-memory databases are more responsive than a conventional disk-optimized database because accessing data in memory is typically faster than accessing data stored on disk. In-memory databases implement in-memory columnar data stores and advanced query optimizations to run analytic queries at an order of magnitude faster than conventional on-disk databases. The in-memory columnar data store is a data structure implemented to store tables and partitions in memory using a columnar format optimized for rapid scans. The in-memory columnar data store resides within a system global area of a server node. The system global area represents a shared memory area used by a database instance to store data that is shared between the database and user processes. Memory within the system global area may be allocated to different memory-consuming components such as the in-memory columnar data store, buffer cache, a shared pool, and redo log buffers.

In order for in-memory databases to perform at orders of magnitude faster than conventional on-disk databases, the in-memory columnar data store needs to have allocated to it a sufficient amount of memory within the system global area. Determining how large of a memory allocation is needed by the in-memory columnar data store may depend on the size of the database and the type of database workload executed. Conventional approaches to managing allocations of memory for the in-memory columnar data store involve a manual trial-and-error approach by a database administrator (DBA). The DBA may analyze database workload information and make an allocation prediction for the in-memory columnar data store based on the database workload information. Once an allocation size for the in-memory columnar data store is selected, it is very difficult to resize the in-memory columnar data store without user disruption.

A DBA may accurately predict an optimal allocation of memory for the in-memory columnar data store for a particular workload. However, if the database workload changes, then the predicted allocation of memory may not be optimal for the new workload. A DBA may then readjust the allocation of memory for the in-memory columnar data store based on the new workload. However, adjustments to the allocation of memory for the in-memory columnar data store may result in user disruptions when the size of the in-memory columnar data store is either grown or shrunk based on changes in the database workload. Additionally, after a potential disruption caused by the change in the allocation of memory for the in-memory columnar data store, there is no guarantee that the database workload will not change again, causing yet another user disruption while the in-memory columnar data store size is again modified.

It is desired to implement a system that automatically evaluates the memory allocation size of an in-memory columnar data store and modifies the size of the memory allocation based on observations of the current workload.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a server node hosting a database service instance, according to an implementation.

FIG. 2 illustrates a process for moving data from an in-memory columnar data store to another memory component for the purpose of freeing up memory granules for reallocation, according to an implementation.

FIG. 3 is a flow diagram that depicts a process 300 for automatically adjusting a memory allocation size for an in-memory columnar data store based on performance prediction data for a plurality of memory-consuming components in a database system, according to an implementation.

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

Techniques are provided for implementing an elastic in-memory columnar data store that is configured to either grow or shrink in response to performance prediction data generated from database workload information. A database server instance running on a server machine contains a shared memory area called a system global area (SGA). The SGA may contain memory-consuming components such as an in-memory columnar data store, a buffer cache, a shared pool, and redo log buffers.

In an implementation, a server node in a database system is running a database server instance. Within the server node, a memory broker maintains allocations of volatile memory, from a given memory area, for a plurality of memory-consuming components. The plurality of memory-consuming components may include an in-memory columnar data store, a buffer cache, a shared pool, redo log buffers, and any other memory-consuming component. The SGA is an example of such a memory area. The memory broker may receive performance prediction data for the plurality of memory-consuming components. The performance prediction data contains performance predictions, for each of a plurality of memory size allocation values for each of the memory-consuming components. For example, the performance prediction data for the in-memory columnar data store may contain:
the available memory allocation size options for the in-memory columnar data store, and
for each allocation size option, corresponding performance prediction data The performance prediction data for an allocation size option represents an estimated database response time for processing queries using the memory allocation size option.

In an implementation, the memory broker determines a target memory allocation for the in-memory columnar data store based on the performance prediction data received from the memory-consuming components. The memory broker may calculate the performance benefits and costs to modifying memory allocation sizes for the memory-consuming components and select a memory allocation size value that produced the largest performance benefit for the in-memory columnar data store while minimizing performance costs to other memory-consuming components. Performance costs to other memory-consuming components occurs because increasing the memory allocation size for a memory-consuming component would cause the memory allocation size of one or more other memory-consuming component to be reduced.

In an implementation, the memory broker determines an incrementally adjusted amount of memory for the in-memory columnar data store based on the target memory allocation and a current memory allocation for the in-memory columnar data store. By incrementally adjusting the amount of memory allocated to the in-memory columnar data store, the memory broker avoids large disruptions to the database workload based on large amount of data evictions due to changing memory allocations. The incrementally adjusted amount of memory is allocated to the in-memory columnar data store.

In an implementation, a memory redistribution service determines how to migrate allocations of memory from one memory-consuming component to another memory-consuming component. The memory redistribution service identifies portions of volatile memory in terms of granules, which represent a defined memory unit size. The memory redistribution service receives a change request from the memory broker to adjust the current memory allocation of the in-memory columnar data store to an incrementally adjusted amount of memory. The memory redistribution service calculates a difference value between the current memory allocation and the incrementally adjusted amount of memory of the in-memory columnar data store. If the difference value indicates that the in-memory columnar data store is to be grown, then the memory redistribution service identifies one or more granules of memory that equal the difference value from one or more other memory-consuming components and evicts the data located in the one or more granules. The memory redistribution service then deallocates the granules and reallocates those granules to the in-memory columnar data store.

If, however, the difference value indicates that the in-memory columnar data store is to be shrunk, then the memory redistribution service identifies and evicts cold data from one or more second granules from the in-memory columnar data store. The memory redistribution service then identifies hot data in the one or more second granules and migrates the hot data to other granules in the in-memory columnar data store. Once the cold and hot data has been removed from the one or more second granules, the one or more second granules may be deallocated, thereby causing the memory allocation size of the in-memory columnar data store to shrink to the size specified by the incrementally adjusted amount of memory.

By implementing a system that automatically evaluates allocations of memory for memory-consuming components, the database system is able to optimize database operation processing by optimizing the memory allocation size of the in-memory columnar data store. Furthermore, by incrementally updating the allocation size of the in-memory columnar data store, the database system reduces disruptions to the database workload that may otherwise occur with drastic memory allocation size changes to memory-consuming components.

### Structural Overview

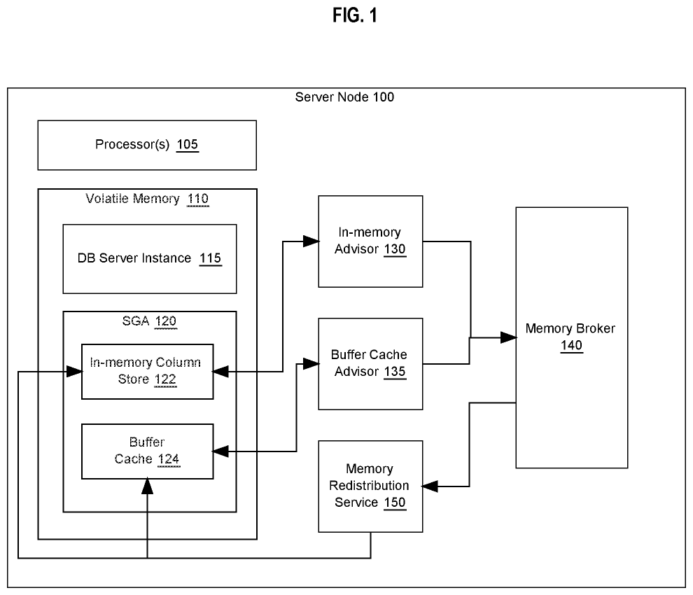

FIG. 1 is a block diagram that depicts a server node hosting a database service instance, according to an implementation. In an implementation, server node 100 includes processors 105, volatile memory 110, in-memory advisor 130, buffer cache advisor 135, memory broker 140, and memory redistribution service 150. Processors 105 represents one or more processors, which are connected to volatile memory 110 via a bus. Server node 100 is implemented to run one or more database (DB) server instances. DB server instance 115 is depicted as being stored within volatile memory 110. The illustrated implementation depicts node 100 as executing a single database server instance, in alternative implementations a single node may execute more than one database server instance.

In an implementation, SGA 120 represents a shared memory area used by database server instances to store data shared between the database server instance and user processes. SGA 120 includes memory allocations for memory-consuming components in-memory columnar data store (IMCS) 122 and buffer cache 124. SGA 120 may contain additional allocations for memory-consuming components not pictured, including, but not limited to, a shared pool and redo log buffers. In an implementation, the SGA 120 is configured to allow allocations of memory to be transferred between one memory component to another memory component. Transferring data between memory-consuming components occurs using units of contiguous memory called granules. A granule is a defined size of a memory unit used to transfer memory between memory-consuming components, such as the IMCS 122 and buffer cache 124. The size of a granule may be dependent on the total size of SGA 120. The larger the SGA 120, the bigger the granule. If SGA 120 is 16 GB and if memory is to be transferred from the buffer cache 124 to the IMCS 122, then the memory would be transferred in units of granules that have a size of 32 MB each. For instance, if the SGA 120 has a size of 8 GB then the granule size may be set to 16 MB. If, however, the size of SGA 120 is 16 GB, then the granule size may be set to a larger size, such as 32 MB.

### Memory Advisor Services

Memory advisor services represent services implemented to analyze memory usage of corresponding memory-consuming components in the SGA 120 and provide a performance prediction for a variety of memory allocation sizes for the corresponding memory-consuming components. The memory advisor services may use database workload information as input to analyze memory usage of the corresponding memory-consuming components to generate the performance predictions.

In an implementation, in-memory advisor 130 represents an advisor service configured to generate performance predictions for different memory allocation sizes for the IMCS 122. For each memory allocation size, the in-memory advisor 130 determines an optimal dataset of data, from DB server instance 115, that should be loaded into IMCS 122. For example, if the different memory allocation sizes include 2 GB, 8 GB, and 16 GB, then the in-memory advisor 130 determines optimal datasets for a 2 GB allocation size, an 8 GB allocation size, and a 16 GB allocation size. The in-memory advisor 130 determines the optimal dataset to be loaded into IMCS 122, for a given allocation size, by identifying tables in DB server instance 115 that qualify for in-memory storage. Each of the tables in DB server instance 115 have table properties that specify whether a table is eligible for population into the IMCS 122. If a particular table is not “in-memory enabled” then the particular table would not be considered by the in-memory advisor for inclusion in the optimal dataset. For tables that are “in-memory enabled”, the in-memory advisor 130 compiles a list of the tables. In other implementations, the in-memory advisor 130 may compile a list of table partitions, columns, or segments that are eligible to be loaded into IMCS 122.

In an implementation, for each table in the list of tables, the in-memory advisor 130 calculates a benefit-to-cost ratio and uses the benefit-to-cost ratio value to rank the tables based on the highest benefit-to-cost ratio. The benefit represents a cumulative query processing time due to having a particular table loaded into IMCS 122. The benefit takes into account a number of full table scans on the particular table over a period of time. For instance, the scan speed for TABLE A is 10 seconds when TABLE A is stored on disk and the estimated scan speed for TABLE A is 2 seconds when TABLE A is loaded into IMCS 122. Database workload information may indicate that TABLE A was scanned 100 times. Based on database workload information and the full table scan speeds for TABLE A, the benefit would be calculated as the difference between the cumulative scan speed for TABLE A stored on disk (scan speed 10 seconds * 100 scans=1000 seconds) and the estimated cumulative scan speed for TABLE A loaded into the IMCS 122 (scan speed 2 seconds * 100 scans=200 seconds), which equals 800 seconds (1000 seconds-200 seconds). The cost represents the expected in-memory footprint for loading TABLE A into IMCS 122. For instance, if loading TABLE A into IMCS 122 would consume 250 MB, then the cost would be 250 MB. Then the benefit-to-cost ratio for TABLE A would be calculated as 200 seconds/250 MB. The in-memory advisor 130 calculates the benefit-to-cost ratio for each eligible table and then ranks the tables based on their benefit-to-cost ratio.

In an implementation, the in-memory advisor 130 determines optimal datasets of data to be loaded into different allocation sizes of the IMCS 122 based on the tables ranked by their benefit-to-cost ratio. The following is a sample list of tables ranked by their benefit-to-cost ratio:

| Table Name | In-memory footprint | Benefit-to-cost value |
|---|---|---|
| TABLE A | 1.8 GB | 0.27 ms/MB |
| TABLE B | 6 GB | 0.25 ms/MB |
| TABLE C | 8.1 GB | 0.08 ms/MB |
| TABLE D | 2 GB | 0.05 ms/MB |

Based on the above sample list of tables, the in-memory advisor 130 determines optimal datasets for each of the possible allocation sizes for IMCS 122. For example, if the possible allocation sizes include 2 GB, 8 GB, and 16 GB, then the in-memory advisor 130 may determine that the optimal dataset for a 2 GB allocation size is only TABLE A. TABLE D may also fit into the 2 GB allocation size, however, the benefit-to-cost ratio for TABLE D (0.05 ms/MB) is much lower than the benefit-to-cost ratio for TABLE A (0.27 ms/MB), as a result the in-memory advisor would select TABLE A over TABLE D. For the 8 GB allocation size, the in-memory advisor 130 may select both tables, TABLE A (1.8 GB) and TABLE B (6 GB), as the optimal dataset based on their in-memory footprint and their benefit-to-cost ratio values. For the 16 GB allocation size, the in-memory advisor 130 may select tables, TABLE A (1.8 GB), TABLE B (6 GB), and TABLE C (8.1 GB) as the optimal dataset.

Upon determining the optimal dataset for the different in-memory allocation sizes, the in-memory advisor 130 calculates an overall performance benefit for each in-memory allocation size. In an implementation, the in-memory advisor 130 determines an overall performance benefit as an estimated database response time for each in-memory allocation size using their corresponding optimal dataset. The estimated database response time, for a given allocation size, is a cumulative estimation of database processing times for database operations that would result in tables scans of data in the IMCS 122, and for database operations that would result in table scans of data on disk. For instance, for each in-memory allocation size, the in-memory advisor 130 estimates per scan response times for in-memory scans and non-in-memory scans. The in-memory advisor 130 uses estimated in-memory scan speeds for the optimal dataset to estimate the in-memory database response times for the optimal dataset, and uses estimated non-in-memory scan speeds for the remaining data not in the optimal dataset to estimate non-in-memory database response times. The in-memory advisor 130 predicts a number full table scans for database operations referencing data that is part of the optimal dataset and a number of full table scans for database operations referencing data that is not part of the optimal dataset and is stored on disk. The in-memory advisor 130 calculates the estimated database response time to be a sum of (1) the estimated in-memory scan speeds for the optimal dataset multiplied by the predicted number of full table scans, and (2) the estimated non-in-memory scan speeds for the remaining data multiplied by the predicted number of full table scans.

In an implementation, the in-memory advisor 130 generates performance prediction data that includes performance predictions for each of the available memory allocation sizes for the IMCS 122. The performance predictions are quantified using the estimated database response times. The following table is a representation of performance prediction data generated by the in-memory advisor 130:

| Database Size | Database response time |
|---|---|
| 2 GB | 12,500 seconds |
| 8 GB | 6000 seconds |
| 16 GB | 4000 seconds |

where the database size column refers to the available allocation size for the IMCS 122, and the corresponding database response times are cumulative database response times for predicted optimal datasets loaded into IMCS 122 and other database data not loaded into IMCS 122. Referring to the table, as the allocation size for the IMCS 122 increases, the estimated database response times decreases. This is because as the allocation size for the IMCS 122 grows, more data may be stored within the IMCS 122, thereby reducing database response times as more database operations access the larger optimal dataset in the IMCS 122.

In an implementation, the in-memory advisor 130, upon generating the performance prediction data, sends the performance prediction data to the memory broker 140. The in-memory advisor 130 may periodically send performance prediction data to the memory broker 140. For instance, the in-memory advisor 130 may send the performance prediction data every minute, every 15 minutes, every hour, every 24 hours, or any other configured duration of time. Alternatively, the in-memory advisor 130 may send the performance prediction data on-demand. The memory broker 140 receives performance prediction data from each of the enabled memory-consuming components and determines the new memory allocations for each of the memory-consuming components that maximizes performance benefits for each of the memory-consuming components.

In an implementation, the buffer cache advisor 135 is an advisor service implemented to generate performance predictions for different memory allocation sizes for the buffer cache 124. Similar to the in-memory advisor 130, the buffer cache advisor 135 generates performance prediction data for multiple allocations sizes for the buffer cache 124. The database response time, in the prediction performance data, generated by the buffer cache advisor 135 may be based on an estimated database processing times that are estimated based on an increased, or decreased buffer size. For example, the available memory allocation sizes for the buffer cache 124 may include 4 GB, 8 GB, and 16 GB. The buffer cache advisor 135 may determine estimated database response times based on real-time database statistics or historical database statistics for processing database operations using different memory allocation sizes. In other implementations where additional memory-consuming components are implemented, the server node 100 may contain additional memory advisors, each configured to generate performance prediction data for their corresponding memory component. For instance, if the SGA 120 contained a shared pool and redo log buffers, then the server node 100 would implement additional memory advisors for the shared pool and redo log buffers.

### Memory Broker

In an implementation, the memory broker 140 is implemented to calculate target memory allocations for memory-consuming components in the SGA 120 based on the performance prediction data received from the in-memory advisor 130 and the buffer cache advisor 135. The memory broker 140 is configured to receive the performance prediction data from the in-memory advisor 130 and the buffer cache advisor 135 and determine new target memory allocation sizes by balancing the costs and benefits for each allocation size for each memory component. If the memory size of the SGA 120 is fixed, then any increase in one memory allocation for one memory component will result in a decrease in memory allocations for one or more other memory-consuming components. In one example, the current memory allocation size for the IMCS 122 may be 4 GB and the current memory allocation size for the buffer cache 124 may be 16 GB. The performance prediction data received from the in-memory advisor 130 may indicate that the greatest performance benefit comes when the target memory allocation size for the IMCS 122 is 8 GB. For instance, the performance prediction data from the in-memory advisor 130 may contain two allocations sizes, 6 GB and 8 GB, where the 6 GB has an estimated database response time of 10,000 seconds and the 8 GB has an estimated database response time of 6000 seconds. The performance prediction data received from the buffer cache advisor 135 may indicate that the best memory allocation size for the buffer cache 124 is 16 GB and the second best memory allocation is 12 GB. The memory broker 140 may determine from the database response times in the performance prediction data that the IMCS 122 should be grown from 4 GB to 8 GB as this target memory allocation size yields the best performance benefit for the IMCS 122. In doing so, the memory broker 140 would need to shrink the allocation size of the buffer cache 124 from 16 GB to 12 GB in order to account for the 4 GB added to the IMCS 122. The decrease in performance associated with decreasing the memory allocation size of the buffer cache 124 from 16 GB to 12 GB is not a significant enough to outweigh the performance gain realized by the increase in the memory allocation size for IMCS 122.

In an implementation, the memory broker 140 may take into account the current workload information in order to determine which memory-consuming components should be grown and which memory-consuming components should be shrunk. For example, if the current database workload information indicates that the majority of the database workload is an analytical workload, then the memory broker 140 may increase the memory allocation for the IMCS 122 and decrease the memory allocation for the buffer cache 124, as in-memory table scans perform much better than buffer cache table scans. Alternatively, if the current database workload information indicates that the majority of the database workload is a transactional workload, then the memory broker 140 may decrease the memory allocation for the IMCS 122 and increase the memory allocation for the buffer cache 124.

Adjusting memory allocations between memory-consuming components may cause performance disruptions if the changes are significant. For example, if the memory allocations for the buffer cache 124 are reduced by 50% and the reduction occurs in a short period of time, such as in one cycle, then database performance may be adversely affected as 50% of the data in the buffer cache 124 would have to be immediately evicted. A cycle may represent a period of time, such as 30 seconds, one minute, or any other defined period of time. In an implementation, the memory broker 140 may use an incremental approach whereby the memory broker 140 makes incremental changes to memory allocations so as not to cause significant database workload disruptions. For example, if the current memory allocation for the buffer cache 124 is 8 GB and the target allocation for the buffer cache 124 is 4 GB, the memory broker 140 may generate instructions to incrementally reduce the memory allocation for the buffer cache 124 over a period of multiple cycles. The memory broker 140 may decide to reduce the buffer cache 124 by 0.5 GB per cycle until the memory allocation for the buffer cache 124 equals the target memory allocation of 4 GB.

Small incremental changes to memory allocations may not be as beneficial to memory-consuming components that need larger chunks of memory. For example, the IMCS 122 contains in-memory columnar units configured to store tables and partitions in memory using a columnar format. In order for the IMCS 122 to optimize table scans and have a sufficient performance benefit, larger chunks of memory should be allocated. If, however, the memory broker 140 makes small incremental changes to the memory allocation of the IMCS 140, the added memory may not have an immediate benefit because the added memory may be too small to load a significant amount of another table or partition into the IMCS 122. For example, if the memory broker 140 grows the IMCS 122 by only a small amount, such as 200 MB, the benefit of the additional 200 MB may not be enough to improve processing performance for an additional table or partition as the additional 200 MB may not be large enough to load a significant amount of the additional table.

In an implementation, the memory broker 140 may implement a non-linear approach to incremental adjustments of memory allocations for the IMCS 122. The memory broker 140 may generate instructions for initial large incremental adjustments to the IMCS 122 and then throttle back to smaller incremental adjustments until the size of the IMCS 122 reaches the target allocation size. For example, if the current memory allocation for the IMCS 122 is 4 GB and the target allocation size is 10 GB, then the memory broker 140 may decide to incrementally adjust the memory allocation for IMCS 122 by 2 GB per cycles for two cycles, then incrementally adjust the memory allocation for IMCS 122 by 0.5 GB per cycle for four cycles. By doing so, the memory allocation for IMCS 122 can quickly grow in order to accommodate new data being loaded into the IMCS 122 before slowing down in order to minimize potential disruptions in other memory-consuming components.

In an implementation, the memory broker 140 may implement a set of ranges representing an amount by which the IMCS 122 needs to grow or shrink before reaching the target memory allocation size. For example, if the difference between the target and current memory allocation sizes is between 2 GB and 6 GB, then the memory broker 140 may incrementally increase by a larger amount, such as 2 GB per cycle. If, however, the difference between the target and current memory allocation sizes is between 0 GB and 2 GB, then the memory broker 140 may incrementally increase by a smaller amount, such as 0.5 GB per cycle. Other implementations may include additional ranges defining difference incremental changes to memory allocation sizes.

In an implementation, the memory broker 140 sends change instructions to modify memory allocations for the IMCS 122 and the buffer cache 124 to the memory redistribution service 150. The change instructions may include an incremental adjustment to memory allocations for memory-consuming components. For example, if the current memory allocation size for the IMCS 122 is 2 GB and the target memory allocation size is 10 GB. The memory broker 140 may initially make an incremental adjustment the memory allocation size by 2 GB, such that the change instructions instruct the memory redistribution service 150 to change the memory allocation size for the IMCS 122 from 2 GB (current size) to 4 GB (the incremental adjustment of adding 2 GB for this cycle).

### Memory Redistribution Service

In an implementation, the memory redistribution service 150 is implemented to receive new memory allocation sizes for memory-consuming components and grow or shrink the memory allocations for memory-consuming components accordingly. For example, current memory allocation sizes for the IMCS 122 and the buffer cache 124 are 2 GB and 10 GB, respectively. The memory redistribution service 150 may receive change instructions from the memory broker 140 to grow the memory allocation size of the IMCS 122 to 4 GB and shrink the memory allocation size of the buffer cache 124 to 8 GB. Upon receiving the change instructions, the memory redistribution service 150 determines that the buffer cache 124 is supposed to shrink by 2 GB. The memory distribution service 150 measures changes to allocation sizes in the form of granules. For instance, if the granule size for SGA 120 is 512 MB (0.5 GB), then the memory redistribution service 150 would need to transfer 4 granules (0.5 GB * 4=2 GB) from the buffer cache 124 to the IMCS 122. The memory redistribution service 150 may trigger buffer cache evictions from the buffer cache 124 in order to free up 4 granules of memory that will be transferred to IMCS 122.

When the memory redistribution service 150 receives change instructions that indicate a shrinking of the IMCS 122, the memory redistribution service 150 will free up granules of memory from the IMCS 122 in order to transfer granules between memory-consuming components. The memory redistribution service 150 may randomly select which data that should be evicted, however, random eviction of data from the IMCS 122 is not optimal because there is no way to ensure which data is removed from and which data remains in the IMCS 122. In an implementation, the memory redistribution service 150 may identify and evict cold data in the IMCS 122 and reorganize hot data in the IMCS 122 in order to free up granules to satisfy the change instructions to shrink the IMCS 122.

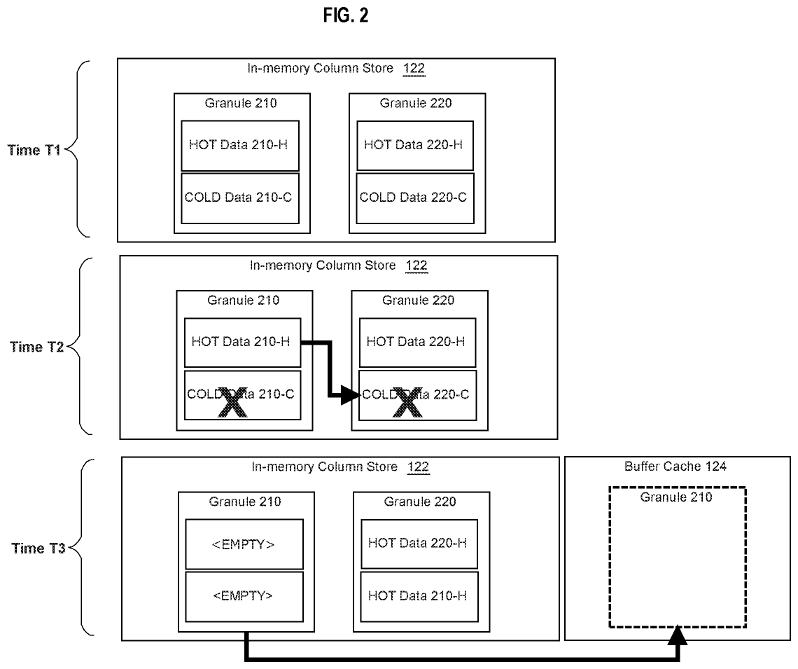

FIG. 2 illustrates a process for moving data from an in-memory columnar data store to another memory component for the purpose of freeing up memory granules for reallocation, according to an implementation. In FIG. 2, time T1 represents an instance in time when the memory redistribution service 150 receives a request to shrink the IMCS 122 by one granule. At time T1, the IMCS 122 contains two granules, granule 210 and granule 220. Implementations of the IMCS 122 may contain more granules than displayed in FIG. 2. Each of the granules 210 and 220 both contain a mix of hot data and cold data. Granule 210 contains hot data 210-H and cold data 210-C. Granule 220 contains hot data 220-H and cold data 220-C. In order to free up a granule, the memory redistribution service 150 needs to remove the data stored in the granule prior to deallocating the granule. In an implementation, the memory redistribution service 150 identifies cold data for eviction. For example, the memory redistribution service 150 may identify cold data 210-C from granule 210 and cold data 220-C from granule 220 and mark them for eviction.

After evicting cold data 210-C and 220-C, from the IMCS 122, the memory redistribution service 150 identifies hot data that needs to be moved in order to free up granules for deallocation. Referring to FIG. 2, time T2 represents a moment in time after identifying cold data 210-C and 220-C. At time T2, the memory distribution service 150 evicts cold data 210-C and 220-C and identifies hot data 210-H, in granule 210, for migration to another granule.

At time T3, the memory redistribution service 150 moves hot data 210-H from granule 210 to granule 220. In an implementation, the memory redistribution service 150 removes the hot data 210-H from granule 210 and repopulates the hot data 210-H in granule 220. The repopulation of the hot data 210-H may be performed at a very rapid rate because there is no need for data transformation. When data is loaded into the IMCS 122 from on-disk storage, the data may be compressed, clustered, or both. In this case, the hot data 201-H in granule 210 has already been compressed according to policies defined for the IMCS 122. Therefore, the repopulating the hot data 210-H in granule 220 may be accomplished at a much faster rate as no compression and/or clustering is required. Granule 220 now contains hot data 210-H and 220-H. Granule 210 does not contain any active data blocks and may be transferred to another memory component, such as the buffer cache 124. FIG. 2 shows granule 210 being reallocated from IMCS 122 to buffer cache 124.

In an implementation, if the memory redistribution service 150, when attempting to free granules, cannot evict enough cold data from the IMCS 122, then the memory redistribution service 150 may evict hot data in order to free granules for reallocation. Additionally, the memory redistribution service 150 may also evict hot data if the data in the IMCS 122 has become too fragmented.

### Process Overview

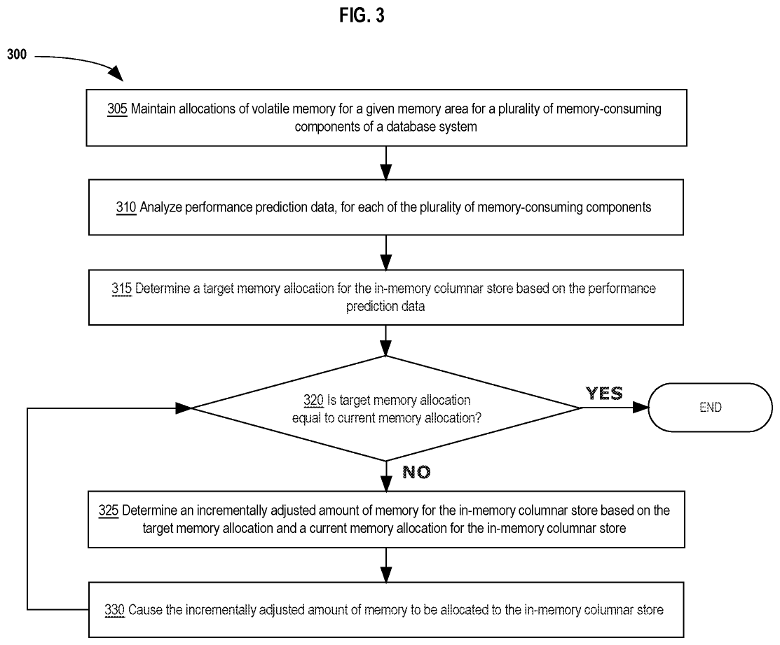

FIG. 3 is a flow diagram that depicts a process 300 for automatically adjusting a memory allocation size for an in-memory columnar data store based on performance prediction data for a plurality of memory-consuming components in a database system, according to an implementation. The steps of the process as shown in FIG. 3 may be implemented using processor-executable instructions that are stored in computer memory. For the purposes of providing a clear example, the steps of FIG. 3 are described as being performed by processes executing in server node 100. For the purposes of clarity, the process described may be performed with more or fewer steps than described in FIG. 2.

At step 305, process 300 maintains allocations of volatile memory for a given memory area for a plurality of memory-consuming components of a database system. In an implementation, memory broker 140 maintains allocations of volatile memory, in the SGA 120, for the plurality of memory-consuming components for DB server instance 115. The plurality of memory-consuming components may include the IMCS 122 and the buffer cache 124. Other implementations of the SGA 120 may include additional memory-consuming components such as a shared pool and a redo log buffer.

At step 310, process 300 analyzes, performance prediction data for each of the plurality of memory-consuming components. In an implementation, the memory broker 140 analyzes performance prediction data from the in-memory advisor 130 and the buffer cache 135. The performance prediction data provided by each of the in-memory advisor 130 and the buffer cache 135 contains performance predictions for a plurality of memory allocation sizes. For example, the in-memory advisor 130 may provide performance prediction data that includes performance predictions for the IMCS 122, if the IMCS 122 was allocated difference allocation sizes. For instance the performance prediction data may include memory allocations for 4 GB, 8 GB, 16 GB, and so on, where each allocation has a corresponding performance prediction.

At step 315, process 300 determines a target memory allocation for the in-memory columnar data store based on the performance prediction data. In an implementation, the memory broker 140 determines the target memory allocation for the IMCS 122 based on the performance predictions data provided by the in-memory advisor 130 and the performance predictions data provided by the buffer cache advisor 135. The memory broker 140 balances the costs and benefits of each permutation of allocation sizes for each of the memory-consuming components. For example, prior to adjustment the memory allocation for the IMCS 122 is 2 GB and the memory allocation for the buffer cache 124 is 18 GB. The performance prediction data from the in-memory advisor 130 indicates the following performance predictions for data stored in the IMCS 122:

| Database Size | Database response time |
|---|---|
| 4 GB | 12,000 seconds |
| 8 GB | 6000 seconds |
| 16 GB | 5000 seconds |

where the database response time represents the cumulative database response times for predicted optimal datasets loaded into IMCS 122 for specific memory allocation sizes. The allocation size of 4 GB represents increasing the allocated memory from 2 GB to 4 GB, resulting in a predicted database response time of 12,000 seconds. Increasing the allocation size from 2 GB to 8 GB would result in a predicted database response time of 6000 seconds. Increasing the allocation size from 2 GB to 16 GB would result in a predicted database response time of 5000 seconds. If the cumulative database response time for the current 2 GB IMCS 122 allocation is 15,000 seconds, then the memory broker 140 would infer the following performance improvements for each allocation size: 4 GB provides a 3000 second improvement, 8 GB provides a 9000 second improvement, and 16 GB provides a 10,000 second improvement.

The performance prediction data from the buffer cache advisor 135 indicates the following performance predictions for data stored in the buffer cache 124:

| Database Size | Database response time |
|---|---|
| 4 GB | 8000 second |
| 12 GB | 1000 second |
| 16 GB | 800 second |

where the database response times represent cumulative database response times for predicted buffer cache sizes for the buffer cache 124. For the above table, the current database response time for the buffer cache 124 (18 GB size) may be 700 seconds. Decreasing the allocation size from 18 GB to 4 GB would result in a predicted database response time penalty of 7300 seconds (8000 seconds for 4 GB-700 seconds for 18 GB). Decreasing the allocation size from 18 GB to 12 GB would result in a predicted database time penalty of 300 seconds (1000 seconds for 12 GB-700 seconds for 18 GB). Decreasing the allocation size from 18 GB to 16 GB would result in a predicted database time penalty of 100 seconds (800 seconds for 16 GB-700 seconds for 18 GB).

Based on the sample performance prediction data from the in-memory advisor 130 and the buffer cache advisor 135, the memory broker 140 may select memory allocations of 8 GB for the IMCS 122 and 12 GB for the buffer cache 124. These allocations yield the best performance benefit for the IMCS 122 while minimizing the performance degradation for the buffer cache 124. Upon determining a target memory allocation size for the IMCS 122, the memory broker 140 may generate change instructions that incrementally change the memory allocations for the memory-consuming components so as not to disrupt database workloads. By incrementally changing memory allocation sizes, the memory broker 140 may issue change instructions that incrementally change the memory allocation sizes over several cycles until the target memory allocation size is achieved.

At decision diamond 320, process 300 determines whether the target memory allocation is equal to the current memory allocation. In an implementation, the memory broker 140 may check the current memory allocation for the IMCS 122 to determine whether additional incremental updates are needed to reach the target memory allocation size. If the current memory allocation size is equal to the target memory allocation size, then the process ends as the target memory allocation size for the IMCS 122 has been reached. If, however, the current memory allocation size is not equal to the target memory allocation size, then the process 300 proceeds to step 325.

At step 325, process 300 determines an incrementally adjusted amount of memory for the in-memory columnar data store based on the target memory allocation and the current memory allocation for the in-memory columnar data store. In an implementation, the memory broker 140 determines an adjusted amount of memory for the in-memory columnar data store based on the difference between the current memory allocation size and the target memory allocation size.

The memory broker 140 may implement a set of ranges for determining the size of the incremental change. For instance, if the difference between the current memory allocation size and the target memory allocation size is greater than 6 GB then the memory broker 140 may incrementally increase the memory allocation size for the IMCS 122 by 4 GB. If the difference between the current and the target memory allocation size is between 2 GB and 6 GB then the memory broker 140 may incrementally increase the memory allocation size for the IMCS 122 by 2 GB. If the difference between the current and the target memory allocation size is less than 2 GB then the memory broker 140 may incrementally increase the memory allocation size for the IMCS 122 by 0.5 GB.

In the previous example, the memory broker 140 determined that the memory allocation size for the IMCS 122 should be increased from the current 2 GB allocation to the target 8 GB allocation. The memory broker 140 determine a range that the difference between the current and target memory allocation sizes falls, in this case the difference between the current and target memory allocation sizes is 6 GB, which falls into the 2 GB and 6 GB range defined above, where the incremental adjustment would be 2 GB, resulting in the incrementally adjusted amount of memory for the IMCS 122 equal to 4 GB. In an implementation, the memory broker 140 generates change instructions and sends the change instructions to the memory redistribution service 150 for implementation.

At step 330, process 300 causes the incrementally adjusted amount of memory to be allocated to the in-memory columnar data store. In an implementation, the memory redistribution service 150 receives the change instructions from the memory broker 140 and calculates the difference between the incrementally adjusted amount of memory to be allocated to the IMCS 122 and the current memory allocation. The difference may be measured in terms of granules of memory. If the incrementally adjusted amount of memory is greater than the current memory allocation, then the memory allocation for the IMCS 122 is to be grown. Since the SGA 120 has a fixed size of memory, in order for the memory redistribution service 150 to grow the size of the IMCS 122, the memory redistribution service 150 will need to reduce the size of allocations of other memory-consuming components. For example, if the IMCS 122 is to be grown by 2 GB, then the buffer cache 124 will be reduced by 2 GB.

The memory redistribution service 150 may reduce the memory allocation size of the buffer cache 124 by identifying and evicting data from one or more granules in the buffer cache 124, where the size of the one or more granules equals the memory allocation size of the buffer cache 124 to be reduced. After the data from one or more granules has been evicted, the memory redistribution service 150 deallocates the one or more granules from the buffer cache 124. The memory redistribution service 150 reallocates the one or more granules to the IMCS 122, thereby increasing the memory allocation size of the IMCS 122 to equal the incrementally adjusted amount of memory value.

If, however, incrementally adjusted amount of memory is less than the current memory allocation, then the memory allocation for the IMCS 122 is to be shrunk. In an implementation, the memory redistribution service 150 identifies and evicts cold data from one or more granules in the IMCS 122. Upon evicting the cold data, the one or more granules in the IMCS 122 may still contain hot data. The memory redistribution service 150 identifies hot data in the one or more granules and migrates the hot data to other granules in the IMCS 122. Once the cold and hot data have been migrated out of the one or more granules, the one or more granules may be deallocated in order to shrink the memory allocation size of the IMCS 122 to equal the incrementally adjusted amount of memory value.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

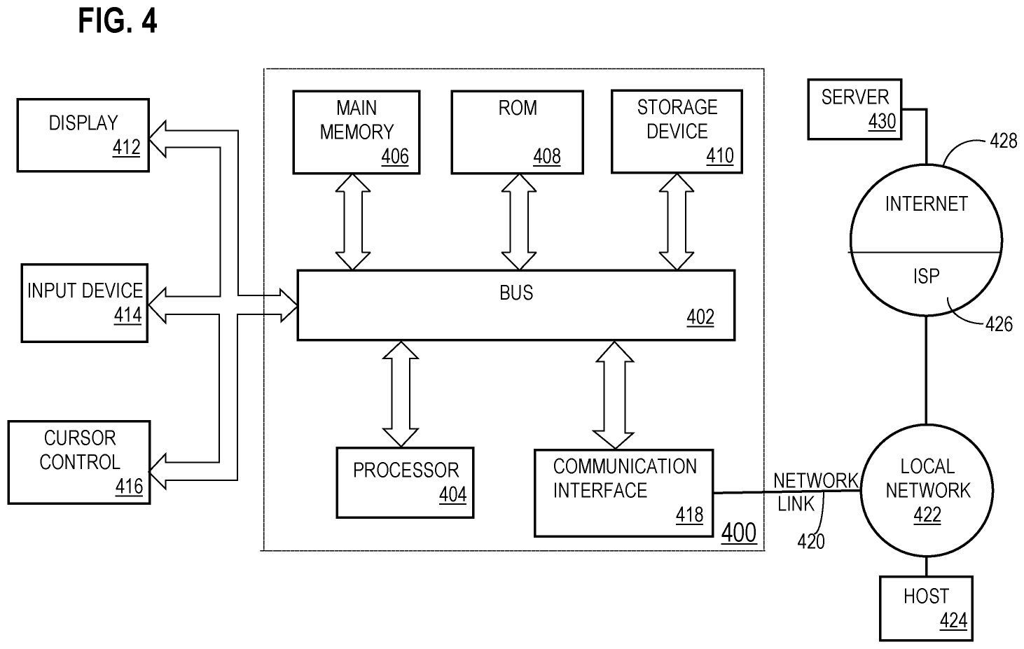

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
maintaining, by a memory broker, allocations of volatile memory from a given memory area for a plurality of memory-consuming components of a database system;
analyzing, at the memory broker, performance prediction data, for each of a plurality of the memory-consuming components, wherein the plurality of the memory-consuming components comprises at least an in-memory columnar data store;
wherein the performance prediction data for each of the plurality of the memory-consuming components comprise a plurality of memory allocation size values and corresponding performance predictions;
based on the performance prediction data received from each of the plurality of the memory-consuming components, determining a target memory allocation for the in-memory columnar data store;
based on the target memory allocation and a current memory allocation for the in-memory columnar data store, determining an incrementally adjusted amount of memory for the in-memory columnar data store;
causing the incrementally adjusted amount of memory to be allocated to the in-memory columnar data store.

2. The method of claim 1, wherein determining the incrementally adjusted amount of memory for the in-memory columnar data store, comprises:
responsive to a difference between the current memory allocation and the target memory allocation being within a first range, determining a first incrementally-adjusted amount of memory;
responsive to the difference between the current memory allocation and the target memory allocation being within a second range, determining a second incrementally-adjusted amount of memory;
wherein the second range is higher than the first range, and the second incrementally-adjusted amount of memory is greater than the first incrementally-adjusted amount of memory.

3. The method of claim 1, further comprising:
upon causing the incrementally adjusted amount of memory to be allocated to the in-memory columnar data store, assigning a new current memory allocation to equal the incrementally adjusted amount of memory;
based on the target memory allocation and the new current memory allocation for the in-memory columnar data store, determining a second incrementally adjusted amount of memory for the in-memory columnar data store;
causing the second incrementally adjusted amount of memory to be allocated to the in-memory columnar data store.

4. The method of claim 1, wherein causing the incrementally adjusted amount of memory to be allocated to the in-memory columnar data store, comprises:
determining that the incrementally adjusted amount of memory for the in-memory columnar data store is less than the current memory allocation for the in-memory columnar data store;
calculating a difference value for a difference between the incrementally adjusted amount of memory and the current memory allocation;
identifying one or more granules in the in-memory columnar data store to be deallocated, wherein the one or more granules equal a particular amount of memory that is equal to the difference value;
identifying and evicting cold data blocks from the in-memory columnar data store;
identifying hot data blocks located in the one or more granules;
migrating the hot data blocks from the one or more granules to one or more other granules in the in-memory columnar data store, wherein the one or more granules and the one or more other granules are separate and distinct granules; and
deallocating the one or more granules.

5. The method of claim 1, wherein the incrementally adjusted amount of memory is a value that is between a current value representing the current memory allocation and a target value representing the target memory allocation.

6. The method of claim 1, wherein the plurality of the memory-consuming components further comprises a buffer cache, a shared pool, and a redo log buffer.

7. The method of claim 1, wherein the performance predictions in the performance prediction data for the in-memory columnar data store are based on calculating a cumulative database response time for executing a database workload on the database system, where the cumulative database response time depends on a prediction of loading an optimal dataset of data into the in-memory columnar data store;
wherein the optimal dataset of data is dependent on the memory allocation size values from the plurality of memory allocation size values.

8. The method of claim 1, wherein the target memory allocation determined for the in-memory columnar data store has a memory allocation size value that produced a largest performance benefit for the in-memory columnar data store while minimizing performance costs to other memory-consuming components in the plurality of memory-consuming components.

9. A method comprising:
maintaining allocations of volatile memory from a given memory area for a plurality of memory-consuming components of a database system;
wherein the plurality of the memory-consuming components comprises at least an in-memory columnar data store that has a current memory allocation;
receiving, by a memory redistribution service, a change request to adjust the current memory allocation of the in-memory columnar data store to an incrementally adjusted amount of memory;
calculating, by the memory redistribution service, a difference value, in terms of a particular number of granules of memory, for a difference between the incrementally adjusted amount of memory and the current memory allocation, wherein a granule of memory is a defined size of memory;
determining, by the memory redistribution service, whether the difference value is a positive value;
in response to determining that the difference value is a positive value, the memory redistribution service:
identifying and evicting an amount of data from one or more first granules of memory from one or more other memory-consuming components of the plurality of memory-consuming components, wherein the one or more first granules of memory equals the particular number of granules of memory;
deallocating the one or more of first granules of memory from the one or more other memory-consuming components;
reallocating the one or more first granules of memory to the in-memory columnar data store.

10. The method of claim 9, further comprising, in response to determining that the difference value is not a positive value, the memory redistribution service:
identifying and evicting cold data from one or more second granules of memory from the in-memory columnar data store;
identifying hot data from the one or more second granules;
migrating the hot data from the one or more second granules to one or more third granules in the in-memory columnar data store, wherein the one or more first granules and the one or more third granules are separate and distinct granules;
deallocating the second one or more granules.

11. A non-transitory computer-readable storage medium storing sequences of instructions that, when executed by one or more processors, cause:
maintaining, by a memory broker, allocations of volatile memory from a given memory area for a plurality of memory-consuming components of a database system;
analyzing, at the memory broker, performance prediction data, for each of a plurality of the memory-consuming components, wherein the plurality of the memory-consuming components comprises at least an in-memory columnar data store;
wherein the performance prediction data for each of the plurality of the memory-consuming components comprise a plurality of memory allocation size values and corresponding performance predictions;
based on the performance prediction data received from each of the plurality of the memory-consuming components, determining a target memory allocation for the in-memory columnar data store;
based on the target memory allocation and a current memory allocation for the in-memory columnar data store, determining an incrementally adjusted amount of memory for the in-memory columnar data store;
causing the incrementally adjusted amount of memory to be allocated to the in-memory columnar data store.

12. The non-transitory computer-readable storage medium of claim 11, wherein determining the incrementally adjusted amount of memory for the in-memory columnar data store, comprises:
responsive to a difference between the current memory allocation and the target memory allocation being within a first range, determining a first incrementally-adjusted amount of memory;
responsive to the difference between the current memory allocation and the target memory allocation being within a second range, determining a second incrementally-adjusted amount of memory;
wherein the second range is higher than the first range, and the second incrementally-adjusted amount of memory is greater than the first incrementally-adjusted amount of memory.

13. The non-transitory computer-readable storage medium of claim 11, the sequences of instructions including instructions that, when executed by the one or more processors, cause:
upon causing the incrementally adjusted amount of memory to be allocated to the in-memory columnar data store, assigning a new current memory allocation to equal the incrementally adjusted amount of memory;
based on the target memory allocation and the new current memory allocation for the in-memory columnar data store, determining a second incrementally adjusted amount of memory for the in-memory columnar data store;
causing the second incrementally adjusted amount of memory to be allocated to the in-memory columnar data store.

14. The non-transitory computer-readable storage medium of claim 11, wherein causing the incrementally adjusted amount of memory to be allocated to the in-memory columnar data store, comprises:
determining that the incrementally adjusted amount of memory for the in-memory columnar data store is less than the current memory allocation for the in-memory columnar data store;
calculating a difference value for a difference between the incrementally adjusted amount of memory and the current memory allocation;
identifying one or more granules in the in-memory columnar data store to be deallocated, wherein the one or more granules equal a particular amount of memory that is equal to the difference value;
identifying and evicting cold data blocks from the in-memory columnar data store;
identifying hot data blocks located in the one or more granules;
migrating the hot data blocks from the one or more granules to one or more other granules in the in-memory columnar data store, wherein the one or more granules and the one or more other granules are separate and distinct granules; and
deallocating the one or more granules.

15. The non-transitory computer-readable storage medium of claim 11, wherein the incrementally adjusted amount of memory is a value that is between a current value representing the current memory allocation and a target value representing the target memory allocation.

16. The non-transitory computer-readable storage medium of claim 11, wherein the plurality of the memory-consuming components further comprises a buffer cache, a shared pool, and a redo log buffer.

17. The non-transitory computer-readable storage medium of claim 11, wherein the performance predictions in the performance prediction data for the in-memory columnar data store are based on calculating a cumulative database response time for executing a database workload on the database system, where the cumulative database response time depends on a prediction of loading an optimal dataset of data into the in-memory columnar data store;
wherein the optimal dataset of data is dependent on the memory allocation size values from the plurality of memory allocation size values.

18. The non-transitory computer-readable storage medium of claim 11, wherein the target memory allocation determined for the in-memory columnar data store has a memory allocation size value that produced a largest performance benefit for the in-memory columnar data store while minimizing performance costs to other memory-consuming components in the plurality of memory-consuming components.
